(19) United States
(12) Patent Application Publication
(10) Pub. No.: US 2006/0284101 A1
(43) Pub. Date: Dec. 21, 2006

(54) Detector assembly

(76) Inventors: Vladimir Peskov, Lidingo (SE); Tom Francke, Sollentuna (SE)

Correspondence Address: HARNESS, DICKEY & PIERCE, P.L.C., P.O. BOX 8910, RESTON, VA, 20195, US

(21) Appl. No.: 11/239,288

(22) Filed: Sep. 30, 2005

(30) Foreign Application Priority Data
Jun. 17, 2005 (SE) 0501399-0

(51) Int. Cl. G01J 1/42

(52) U.S. Cl. 250/373; 250/372

(57) ABSTRACT

The invention is related to a detector assembly for detecting vapours, smoke and flames, comprising a detector unit 1 having a UV sensitive photocathode 3, an anode 5, a voltage supply unit 9 connected to the UV sensitive photocathode 3 and to the anode 5 to create an electric field such that photoelectrons emitted from the UV sensitive photocathode 3, when struck by UV light, are forced to move towards the anode 5, and a readout arrangement for detecting charges induced by electrons moving towards the anode 5 thereby generating a signal related to the intensity of detected UV light. The detector assembly further comprises an artificial source 21 for emitting radiation having wavelengths within a wavelength interval, the source 21 being oriented such that UV light from the source 21 can strike the UV sensitive photocathode 3. The wavelength interval coincides with a transmission band of air, and with an absorption band of vapours containing molecules of a complex structure. If a decrease of the signal between the detector 1 and the source 21 is detected a presence of a vapour can be established. The invention is also related to such a method.

### FIELD OF THE INVENTION

The present invention is related to the field of detectors, and in particular to a detector assembly for detecting vapours as defined in the preamble of claim 1, and a method for detecting vapours as defined in claim 23.

### BACKGROUND OF THE INVENTION

It is most natural that people want to protect their life and property, and to this end there is an abundance of different kinds of detector devices available. Fire detectors, smoke detectors and gas detectors are examples of such detectors, and they are frequently used in households with the purpose of increasing the safety by giving an as early as possible warning of potential dangers.

Generally, smoke detectors are based on the detection of smoke aerosols by adsorption of smoke particles on atmospheric ions or by detecting optical effects in such smoke aerosols, for example detecting the scattering of optical radiation. There are several drawbacks with such smoke detectors. For example, it is hard to prevent false alarms, since they may go off when detecting other particles besides smoke aerosols, e.g. dust or insects. Therefore they have to be cleaned rather frequently, which is time consuming and often troublesome for the user and entails a high cost of maintenance.

Various gas detectors are also known. The presence of a certain detrimental gas is usually detected by collecting a sample to be examined, irradiating the sample by light of a particular wavelength upon which the transmission loss is determined and the presence (or absence) of the particular gas can be established. One drawback with this procedure is that one has to known which detrimental gas to scan for. Further, it is a procedure involving several steps and therefore time consuming and laborious. This is a severe shortcoming of the prior art gas detectors, since it is very important to be able to quickly determine the presence of a detrimental gas in order to give an early warning. Further, there are many sources of potential errors in this state of the art gas detection procedure, due to the multiple steps included in the procedure.

### SUMMARY OF THE INVENTION

An object of the present invention is to provide improved vapour detection, enabling the detection of vapour in a reliable yet simple way, not requiring various steps to be performed.

A further object of the invention is to provide a detector assembly with increased sensitivity, and also a less expensive detector assembly.

These objects, among others, are achieved by a detector assembly as claimed in claim 1, and by a method as claimed in claim 22.

Further, there is a need to protect different premises against all kinds of dangers, such as hazardous gases, fire and smoke from a fire. However, to arrange a number of different detector devices in an environment to be supervised, such as a house, is forcing the user to perform maintenance of several devices, for example changing power sources and cleaning the detectors, which is time consuming and troublesome.

Moreover, it is often necessary to place several detectors of the same kind (for example fire detectors) in the different places of the supervised premises, such as in different rooms of a house, which may be perceived as unaesthetic. It would thus be advantageous to be able to include several different detection functions within a single detector device in a simple and convenient, yet reliable way.

Further yet, many of the devices are designed either for supervision of large areas, such as forests, or smaller areas, such as individually supervised houses. It would be advantageous to be able to provide a device and method by which larger areas as well as smaller areas are supervised. An important function saving lives and values is the detection of forest fires. Such detection function is preferably also enabling the user to locate the fires, thereby possibly further improving the speed of initiating counteractions.

Thus there is also a need to provide an apparatus and method improving the protection of life and property in many aspects.

It is therefore a further object of the present invention to provide a multifunctional detector assembly increasing the safety for people, and also increasing the reliability and versatility of detectors by enabling detection of flames as well as smoke and hazardous gases.

It is a further object of the present invention to provide a detector assembly detecting a fire and accelerating the initiation of counter-measures by including the feature of positioning a fire.

These latter objects are achieved by a detector assembly as claimed in claim 2 and by a method as claimed in claim 23.

In accordance with the present invention the above mentioned objects are achieved by a detector assembly for detecting vapours, comprising a detector unit including a UV sensitive photocathode, an anode and a voltage supply unit connected to the UV sensitive photocathode and to the anode. An electric field is created such that photoelectrons emitted from the UV sensitive photocathode are forced to move towards the anode when struck by UV light. Further, a readout arrangement is included for detecting charges induced by electrons moving towards the anode, thereby a signal related to the intensity of detected UV light is generated. An artificial source for emitting radiation having wavelengths within a certain wavelength interval is oriented such that UV light from it can strike the UV sensitive photocathode. The wavelength interval is chosen so as to coincide with a transmission band of air, and also with an absorption band of vapours containing molecules of a complex structure. The readout arrangement is now able to detect a decrease of the signal between the detector and the source should there be a presence of a vapour. The detector assembly in accordance with the invention is able to detect flames as well as smoke and hazardous gases, thereby greatly improving the detection ability, and more specifically widening the range of detection functions performed by a single detector assembly, and thus increasing the safety of a user. Further, since the detector comprises relatively few components it can be made small-sized and thereby attractive for use by house-owners. A single detector is thus able to detect a multitude of potentially life threatening dangers, the detector being a multi-functional detector fulfilling several detection tasks.

In accordance with one embodiment of the invention the wavelength interval is rather narrow, a preferred interval being 121.6 nm±5 nm, and a most preferred interval being 121.6 nm±0.5 nm. Within this interval the air absorption is at a minimum, while the absorption of vapours of complex molecular structure has a maximum. This gives a reliable detection of the light emitted from the artificial source, at the same time as a reliable detection of vapours is achieved.

In accordance with another embodiment of the invention the detector assembly is arranged to detect both flames and vapours. By having the detector unit detecting UV radiation from flames between the regular emissions from the artificial source both vapour detection and flame detection is provided. In accordance with an embodiment of the invention this is accomplished by arranging the artificial light source to emit pulsed radiation and the detector unit to detect this pulsed light at regular intervals, whereby the vapour detection is performed in-between. In another embodiment this dual-function detection is accomplished by utilising spectral filtering, and in yet another embodiment by utilising several detector units provided with filtering means for detection of flames or the artificial source. The detector assembly is thereby able to detect flames and fire as well as the gas and smoke detection. If the interval at which the artificial source emits light is made short, such as for example every other second, the presence of gas or smoke may be detected very rapidly, thereby giving an early alarm. Shortening the interval further yet results in the dual detection function being performed essentially simultaneously.

In accordance with yet another embodiment of the invention the distance between the detector unit and the artificial source is a few cm, preferably about 1 cm. This gives a very reliable detection besides enabling a small-sized detector assembly to be built.

In accordance with yet another embodiment of the invention the detector unit and the source are arranged within a low-pressure chamber. This enhances the sensitivity of the detector assembly, by having a wider spectral interval contributing to the absorption measurements.

In accordance with yet another embodiment of the invention the air is forced to pass between the detector unit and the artificial source. This is especially advantageous in environments with stagnant air, since detection of vapours may still be performed reliably by means of this forced circulation.

In accordance with yet another embodiment of the invention the detector unit and the artificial source are comprised within a housing comprising one or more air inlets. Further, the air inlets may be provided with filtering means for filtering large-sized particles. This is beneficial in particle rich environments, where the rate of false alarms could otherwise be higher due to the particles.

In accordance with yet another embodiment of the invention the vapours to be detected are for example smoke from a fire, gasoline vapour, alcohol vapour or hazardous vapours. In fact, the vapour to be detected may be a wide range of vapours constituted by molecules containing more than three atoms. Thus a variety of vapours may be detected giving a high level of security to the user.

In accordance with yet another embodiment of the invention the artificial source comprises a gas tight chamber including a wire connected to a voltage supply. The gas tight chamber preferably contains a gas filling of Ar or H₂ at a pressure of 1 atm or below, whereby a strong emission of light of wavelength 121.6 nm is provided. Further, the wire may be arranged so as to create a corona discharge having a strong emission at λ=121.6 nm, further strengthening the emission at this particular wavelength.

In accordance with one embodiment of the invention the photocathode comprises a double layer, a first layer of CsTe or SbCs and a coating of CsI. This feature provides a detector assembly having an increased sensitivity, and providing a less expensive detector assembly.

The present invention is also related to such a method, whereby advantages corresponding to the above described are achieved.

Further characteristics of the invention, and advantages thereof, will be evident from the following detailed description of preferred embodiments of the present invention and the accompanying FIGS. 1-9, which are given by way of illustration only, and are not to be construed as limitative of the present invention.

### BRIEF DESCRIPTION OF THE DRAWINGS

FIG. 1 shows a prior art flame detector.

FIG. 2 shows a schematic view over an embodiment of the invention, clarifying the principles of the invention.

FIG. 3 shows another embodiment of the invention including a low-pressure chamber improving the sensitivity of the embodiment of FIG. 2.

FIG. 3a shows another embodiment of the invention including a spectrograph which enables the identification of a gas.

FIG. 4 shows position sensitive sensor illustrating the positioning feature of the invention.

FIG. 5 illustrates more in detail en exemplary embodiment of the position sensitive sensor of FIG. 4.

FIG. 6 shows another embodiment of a detector assembly for positioning a fire and distinguishing between fire and sun-light reflections.

FIG. 7 shows a stereoscopic system comprising position sensitive sensors of FIG. 4.

FIG. 8 shows graphs of quantum efficiencies Q for different materials, as well as the emission spectra of flames in air and emission spectra of the sun.

FIG. 9 shows a schematic view of a double layer photocathode in accordance with one embodiment of the invention.

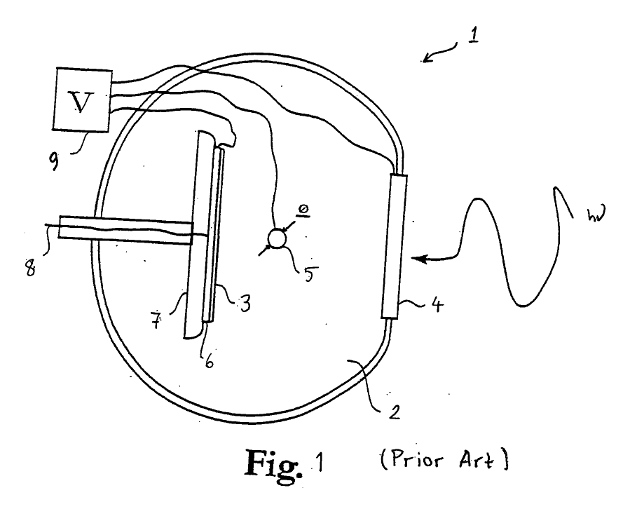

### DETAILED DESCRIPTION OF PREFERRED EMBODIMENTS

The present invention is based on a flame detector previously described in the International publication WO 02/097757, assigned to the same applicant as the present application. This state of the art flame detector 1 comprises a gas tight detection chamber 2 filled with a gas suitable for electron multiplication. An UV photon sensitive photocathode 3 is placed within the chamber 2 on a UV transparent window 4 in such a way that UV light from a flame can strike the UV sensitive photocathode and be absorbed. Further, an anode in the form of a wire 5 is arranged parallel to the UV sensitive photocathode 3 at a suitable distance. A voltage supply unit 9 is connected to the photocathode 3, the anode wire 5 and to a readout arrangement 6-8 such that an electric field is created between the photocathode 3 and the anode wire 5, whereby a concentrated electric field is created around the anode wire 5. UV photons from a flame hit the photocathode 3 and electrons are thereby released. The electrons will be accelerated in the electric field and move towards the anode wire 5, possibly interacting with a gas within the chamber 2 and thereby creating an avalanche amplification of electrons.

The readout arrangement 6-8 is adapted to detect charges induced by the moving electrons and to convert these detected charges into a readout signal indicative of the presence of a flame or spark in front of the detector.

As is known within the field, when light having a continuous wavelength distribution passes through a media, such as for example a gas, some wavelengths are absorbed stronger than others, and may therefore become weaker or be missing in the outgoing light. This gives rise to an absorption spectrum that is characterising for the absorbing medium or substance. Air absorbs practically all UV radiation of wavelengths below 185 nm, in particular in the spectral interval of 100-185 nm and of varying degree for other UV radiation wavelengths.

However, the inventors of the present invention have discovered that there is a particularly low air absorption of light of wavelength λ=121.6 nm, that is, there is a narrow transmission band for ultraviolet light of wavelength λ=121.6 nm. The inventors of the present invention have further discovered that, in contrast to this, many hazardous vapours have a strong absorption band in air at the wavelength λ=121.6 nm. In accordance with the invention, this knowledge is utilised for highly sensitively detecting vapours, and in particular hazardous vapours, which will be described next.

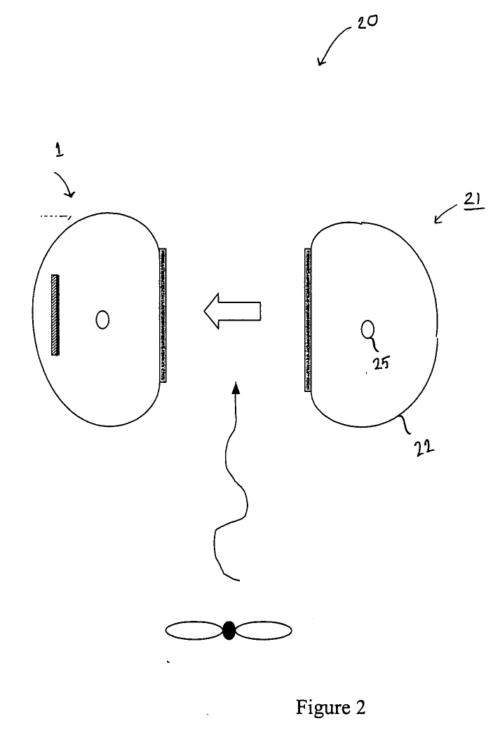

With reference to FIG. 2, an embodiment of the present invention is shown. First recapturing and detailing the earlier described discoveries and their applicability: there is a particularly low air absorption of light of wavelength λ=121.6 nm, i.e. there is a narrow transmission band for ultraviolet light of wavelength λ=121.6 nm. In other words, there is an interval for which the absorption of air has a minimum, and the width of this interval is rather narrow: ±0.5 nm. This wavelength interval in air thus gives a usable transmission band in air. At a short distance, such as for example a few millimetres up to a few centimetres, some fraction of the light from a source emitting at this particular wavelength is able to reach a detector. Thus, as is shown in the figure, a detector assembly 20 in accordance with the invention comprises a detector, such as a detector unit 1 described above, and a source 21 emitting light with the wavelength of 121.6 nm. The detector unit 1 is arranged at some distance from the source 21. The ultraviolet radiation from the source 21 is peaked at λ=121.6 nm, having the above-mentioned narrow width of about +0.5 nm. The detector unit 1 is therefore able to detect the emission from the source 21. The most preferred wavelength interval is 121.6±0.5 nm, but other intervals such as 121.6±5 nm, 121.6±3 nm or 121.6±1 nm are of course also conceivable.

The design of the source 21 can be made very simple, giving a non-expensive solution. For example, the source 21 could basically have the same design as the detector unit 1, but without a photocathode. The source 21 should comprise a gas tight detection chamber 22, preferably filled with Ar or H₂ at a pressure of up to 1 atm. The detection chamber 22 further comprises a wire 25, for example centrally placed. If a high voltage is applied to this central wire 25 a corona discharge will appear and this discharge has a strong emission at λ=121.6 nm. This emission passes the gap between the source 21 and the detector unit 1 and cause a steady signal in the detector unit 1, as was described earlier, but now due to the source 21 instead of a flame as in the previously known flame detector.

Some gases that are excited by an electrical discharge such as the corona discharge described above, emit strong lines at 121.6 nm. Examples of such gases are Argon, Ar, or hydrogen gas, H₂, which is why they are much preferred as the gas filling of the detection chamber 22. It is thereby possible to get a strong narrowband emission at the desired wavelength in a simple and efficient way.

Now again detailing the discoveries of the inventors: in contrast to air, gases with a complicated molecular structure have a particularly strong absorption of light with the wavelength 121.6 nm. A complicated, or complex, molecular structure is to be understood as molecules having more than three atoms, and a “simple” molecular structure is molecules having double or triple atoms. Examples of gases having a complex molecular structure are gasoline vapours, alcohol vapours such as ethanol (C₂H₅OH) gases or methanol (CH₃OH) gases, or toxic fumes like methyl bromide (CH₃Br) or the like. On account of the strong absorption of light of the particular wavelength emitted by the source 21, the intensity of the ultraviolet light at λ=121.6 nm will be attenuated if such vapours appear in the air between the source 21 and the detector unit 1, and, accordingly, the steady signal caused by the emission will decrease upon the presence of such gas. The presence of hazardous vapours may thus easily be established by means of the readout arrangement 6-8, and an audible and/or tactile alarm be effected.

The distance between the source 21 and the detector unit 1 may be optimized for the detection of some particular vapour. For example, if the distance between the source 21 and the detector unit 1 is about 1 cm, the absorption by CO₂ of light of the wavelength λ=121.6 nm is only approximately 4.5%. If the distance is increased to about 10 cm, the absorption will be noticeable. Any appearance of additional CO₂ as compared to a normal concentration in air will thereby be detected. In accordance with an embodiment of the present invention, the source 21 and detector unit 1 are placed a few centimetres apart, for example at a distance of about 1 cm. This distance is preferred in order to give the most reliable detection. A small and handy all-in-one fire and vapour detector is thereby provided, which may easily and conveniently be placed within a house. However, even larger distances are contemplated by using the principles of the present invention.

The detection of flames and vapours may be performed essentially simultaneously. The artificial source 21 may work in a pulsed mode. The artificial light source 21 may be arranged to emit pulsed radiation of the desired wavelength at regular intervals, for example once a second. The detector unit 1 is then arranged to detect this light at the specific moments, thereby detecting a decrease of the signal due to vapour attenuating the signal. The detector 1 can then detect UV light from flames the remaining time. Thus, by having the detector unit detecting UV radiation from flames between the regular emissions from the artificial source both vapour detection and flame detection is provided. If the interval at which the artificial source emits light is made short, such as for example every other second, the presence of gas or smoke may be detected very rapidly, thereby giving an early alarm. Shortening the interval further yet results in the dual detection function being performed essentially simultaneously.

The simultaneous detection of flames and vapour may be achieved in alternative ways. For example by utilising spectral filtering, or by utilising two detector units provided with filtering means for detection of flames or the artificial source.

If the environment in which the detector device in accordance with the invention is utilised has rather still-standing air, or if it is desired to increase the reliability of the detector device, i.e enabling the detection of the entire volume of air within an area, the air circulation may be enhanced in some way. An artificial air circulation may be utilized, for example by means of a ventilator. Thus, a continuous monitoring of hazardous vapours even in large volumes of air can be accomplished.

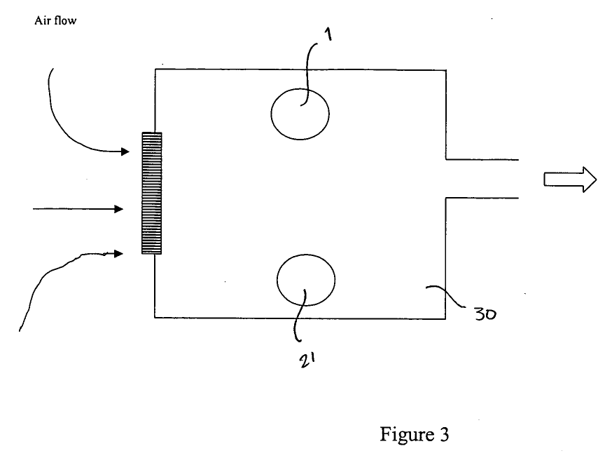

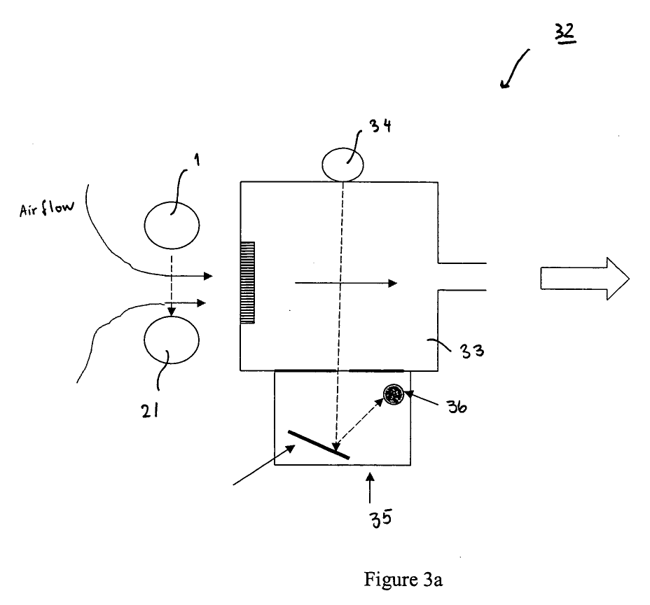

With reference now to FIG. 3, an alternative embodiment of the present invention is shown. In this embodiment the air circulation is not in open space, but in a low-pressure chamber. A detector assembly 20 in accordance with the invention comprises a source 21 and a detector unit 1 as described in connection with FIG. 2, and are arranged within a low-pressure chamber 30. At low pressure the absorption of the air in the gap between the source 21 and detector unit 1 will be reduced further yet, resulting in a UV radiation having a much broader spectrum reaching the detector unit 1, i.e. not only λ=121.6 nm as in the first embodiment, but the entire spectral interval from about 120 to about 185 nm. Thus radiation of a broader spectral interval will penetrate into the detector unit 1. As in the first embodiment, if hazardous vapours appear in the gap between the source 21 and the detector unit 1 a decrease of the signal caused by the light striking the photocathode, which is then emitting electrons causing the signal, is detected. By means of this embodiment, the sensitivity of the detector device can be improved, as a larger interval, namely from 120 to 185 nm, will contribute to the measurements.

One way to achieve a low-pressure chamber is by the well-known phenomenon of capillarity, such as used in a differential pump. This technique is commonly used in vacuum ultraviolet spectroscopy and in molecular beam studies. The system with a differential pump usually contains a gas chamber separated from the ambient air via a capillary having a small diameter. If the chamber is continuously pumped through another port, the pressure in the chamber will be well below 1 atm due to the capillary having a high resistance against the airflow. Other ways to achieve a low-pressure chamber is also conceivable.

In accordance with another embodiment of the invention, the hazardous vapours are identified. FIG. 3a shows a schematic layout of an exemplary apparatus for use in such vapour identification, which is based on the same principles as the embodiments described earlier, but with a gas identification feature included. Air is passed through a detector assembly 1, 21 into a differential chamber 33. The gas identifier 32 is triggered only if the detector assembly 1, 21 identifies a hazardous vapour by the detector unit 21 receiving an attenuated signal, as was described above. The gas identifier 32 comprises a differential pump chamber 33, to which a lamp 34 with a broad emitting spectrum is attached. The gas identifier 32 further comprises a conventional spectrograph 35 containing a detector 36 for detecting the broad spectrum light, emitted from the lamp 34. This arrangement will enable the measuring of the absorption spectra of the gas pumped to the differential chamber 33. Since each gas mixture has its unique absorption spectra, as is known within the field, the measurements of the absorption spectra render it possible to identify the particular gas in question, which may be very useful. For example, different gases may be arranged to trigger different alarms signals in dependence of its potential dangerousness, or may cause different countermeasures to be taken.

In all of the embodiments described above with reference to FIGS. 2, 3 and 3a, the source 21 and detector unit 1 can be housed within a single casing (not shown) containing air passages or inlets for the intake of air to be detected. Further, a filter may be placed in front of the air inlets of the casing, for example in cases where the environment in which the detector assembly is to be used is known to be dust-laden or filled with larger particles. The risk of false alarms is thereby reduced.

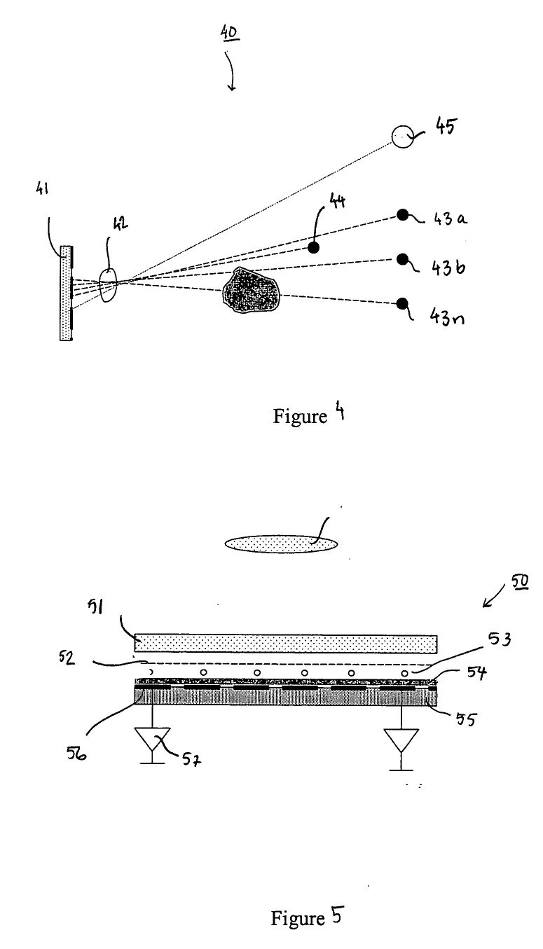

The versatility of the detector assembly 20 can be further increased by using a position sensitive UV detector combined with an optical system, as will be described with reference to FIG. 4. In accordance with this aspect of the invention UV images of the particular emitting sources in a particular area of interest can be imaged. When used in a detector assembly, one can supervise and for example obtain UV images of large-area zones such as hangars, forests or the like. Such system has obvious advantages compared to fire detectors without a positioning feature in that fire-fighting operations can be directed accurately. Further, a flame detector not having a position-sensitive detector may have a higher rate of false alarms, since direct sunlight might trigger the alarm, believing the direct sunlight to be a flame.

FIG. 4 shows a schematic view of an optical system 40 comprising a lens 42 and a number or modulated artificial UV sources 43a, 43b, . . . , 43n, for example Hg lamps. The system further includes an UV position-sensitive detector 41. The UV position-sensitive detector 41 is placed in the focal plane of the optical system 40. Further, a lens 42 is included for imaging UV sources 43a, 43b, . . . , 43n onto a UV sensitive photocathode within the detector 41. An exemplary position sensitive detector 41 will be described below with reference to FIG. 5, but briefly, it comprises readout elements adapted to separately detect charges induced by electrons moving towards each anode wire. These separately detected charges are converted into a readout-signal indicative of the image of the UV sources. Hereby a two-dimensional imaging of the UV sources is accomplished. The position-sensitive detector 41 obtains images of the modulated, artificial UV sources 43a, 43b, . . . , 43n and images of the sun. Further, since flames emit UV light, the position-sensitive detector 41 will also obtain images of any possibly existing fire 44. The modulated UV sources 43a, 43b, . . . , 43n are placed within the area being supervised, and produces images with well known coordinates. The sun as an UV source also has a known position, so the sun and the modulated UV sources 43a, 43b, . . . , 43n can easily be prevented from setting off the fire alarm. However, if there is a fire, the signal produced by the photocathode will be altered and the fire will be detected.

Further, by analogy with the embodiments described in connection with FIGS. 2 and 3; if smoke appear between the modulated UV sources 43a, 43b, . . . , 43n and the position-sensitive detector 41, the signal from the sources 43a, 43b, . . . , 43n will be attenuated and this could be used for setting of the smoke alarm detector.

FIG. 5 shows an example of a position-sensitive detector suitable for use in a system for detecting fire and/or smoke. The exemplary position sensitive detector shown is a wire chamber with readout pads. The detector 50 comprises a UV-transparent window 51 for letting through UV light from UV emitting sources, such as the sources 43a, 43b, . . . , 43n or a fire 44. A metallic mesh 52 is placed below the window 51 and serves, together with metallic pads as cathodes. The cathode 55 of the detector 50 also comprises readout elements, or pads 56, connected to a charge-sensitive amplifier 57. Now, if UV radiation enters the wire chamber 50 via the window 51 a photoelectric effect is caused from the CsI layer 54, and photoelectrons will be ejected from this layer into the detector volume. The applied electric field will influence these primary photoelectrons to move toward the anode wires 53. In the vicinity of the anode wires 53, where the electric field is strong, the primary photoelectrons will trigger Townsend avalanches. The positive ions created in these avalanches will move towards the cathodes, i.e. the metallic mesh 52 and the pads 56, and induce a signal on the pads 56. These signals are then used in order to determine the position of the primary electrons that triggered the avalanches. From the measured position of the created primary photoelectrons it is possible to restore the position of the UV photons that interacted with the CsI photocathode and thus obtain an image of the UV sources focused by the optical system on the detector window 51. In an alternative embodiment the window 51 is excluded and only a lens is utilised.

Sun background light comprises scattered UV light and sunlight caused by long wavelengths, having λ>330 nm. The sun background light will give weak signals in all channels of the position-sensitive detector and can thus easily be distinguished from a fire. Further, it is known that the UV sunlight within the wavelength interval of 185-280 nm is strongly shielded by the upper layer of the atmosphere owing to the ozone and other gases comprised therein. The full transmission through the upper atmosphere occurs only for light having λ>300 nm, whereas on the surface of the earth, the air is transparent (i.e. not absorbing light) in the interval of 240-300 nm. Thus, if there are any emitters on the surface of the earth emitting light of the wavelengths within the interval 240-300 nm they will be detected with high signal to background ratio. As was mentioned earlier, a non-position flame detector might give a false alarm in case of being struck by direct sunlight. In contrast, if direct sunlight penetrates the position sensitive detector, it will cause strong signals, but only in one or a few channels. Since the position of the sun in the sky, and thus the position of the sun image in the focal plane of the optical system, is known, this signal can be excluded from triggering an alarm. Further, the pads reacting on the sun image signal can be electrically disconnected from amplifiers, if any. This will block any current flow between the pads affected by the sun images and the anode wire. The absence of a current flow will in turn save the CsI layer of the photocathode against a possible aging effect (i.e. degradation of the CsI quantum efficiency), otherwise caused by strong UV radiation. Without the fire or the direct sunlight, the aging effect will anyhow be negligibly small, since the background signal is usually very weak.

It is to be noted that other cathodes besides CsI could be used, including gaseous photocathodes. For example, comprising ethylferocene, tetrakis(threemethyl)amine or tetrakis(dimethylamino)ethylene (TMAE) vapours. In contrast to solid photocathodes their quantum efficiency is really zero for wavelengths>200-220 nm, and are thus totally non-sensitive to the long wavelengths emitted by the sun.

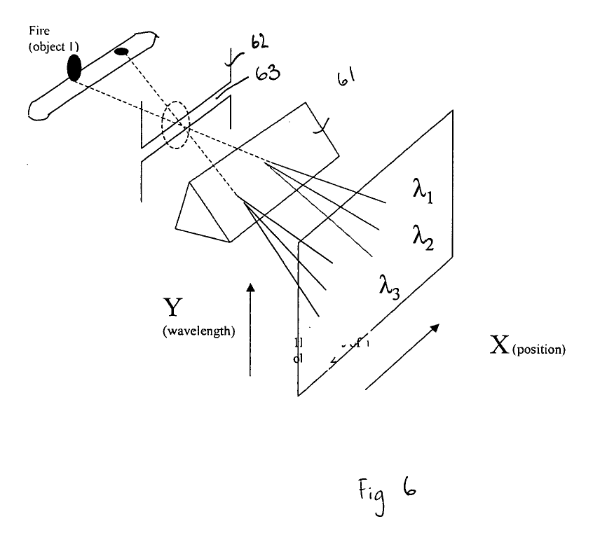

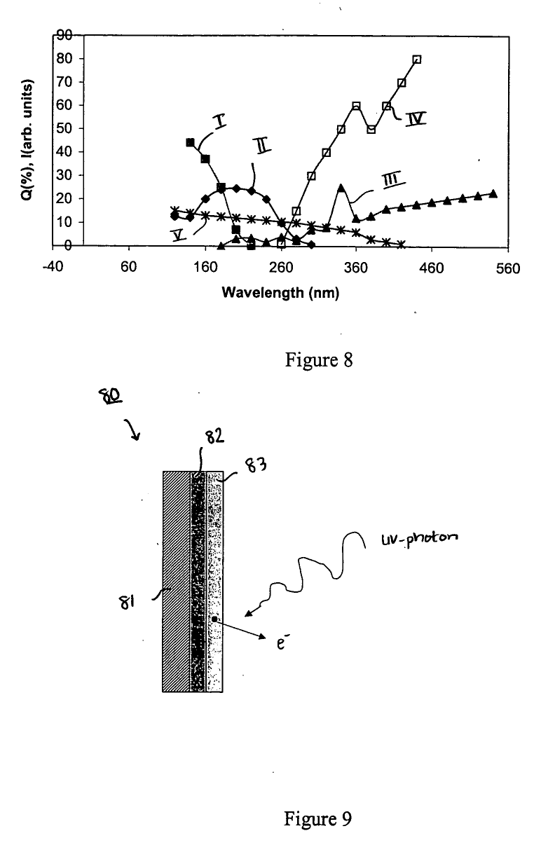

The detector assembly of FIG. 4 is well suited for operation in environments having low background light, for example for use in detecting forest fires. In such application the UV and visible light background from the sun and from the landscape may be accurately predicted, and can thus easily be included in a software package used, set to give an alarm signal. However, in environments having high background this is more difficult. In high background light environments, especially if the background light is highly unpredictable, the system is easily triggered in false. Examples of such high background light environments are: industrial and urban areas and highways, etc. in which unpredictable sunlight reflections from cars, windows and buildings may trigger a false alarm. One way to avoid false alarms is using gaseous photocathodes, which are not sensitive to the long wavelengths emitted by the sun, but sensitive to the short wavelengths emitted by fires. An example of a material suitable for such photocathodes is tetrakis(dimethylamino)ethylene (TMAE), available and usable for gaseous-based, liquid or solid state detectors. A further improvement in this regard is accomplished by the embodiment shown in FIG. 6. The system is similar to the one shown in FIG. 4, but a quartz prism 61 is added, and a lens 62 including a slit 63. A light beam is collimated by the slit 63 and passed to the prism 61. The light is deflected into several beams coming out from the prism 61 at various angles. The light with a particular wavelength will come out at a particular angle. Along the Y-axis of the position sensitive detector assembly, the emission spectrum for the observed point (object 1) is obtained, whereas, along the X-axis, a 1D image of the surveyed area is obtained. This arrangement enables the simultaneous measurements of the position and the spectra of a fire or the sun-reflecting object. As is evident from FIG. 8, a fire in air has a spectrum different from the spectra of sunlight: the fire has a peak of molecular emission between 300 and 360 nm, whereas the sun emits as a black body and has a sharply growing spectra in this spectral area. With the described arrangement it is possible to reliably distinguish between a fire and the reflective sunlight by measuring the spectra. Further, the measurements of just a few wavelengths around the peak of the fire emission will be sufficient. For example, the measured ratios: I₁/I₂ and I₃/I₂, where I₁, I₂, I₃ are the measured intensities of the radiation at wavelengths illustrated as λ₁, λ₂ and λ₃, will be sufficient.

A few examples of position-sensitive detectors suitable for use in the present invention are: a wire chamber (described above with reference to FIG. 5), a parallel-plate chamber combined with CsI (or CsTe or SbCs) photocathode and with pad-type of readout arrangement, a solid-state detector or vacuum detector. Wire chamber detectors and parallel-plate chamber detectors are preferred to the latter ones, since they are less expensive, can have very large sensitive areas, i.e. the area of the detector where an incident radiant power results in a measurable output, and they are able to detect a single photoelectron emission. It is understood that other UV position-sensitive detectors may be used as well.

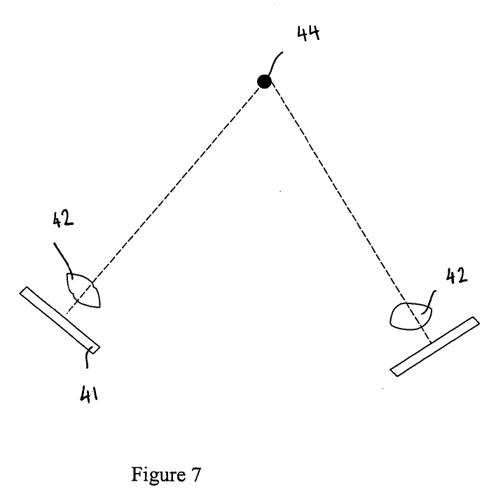

FIG. 7 shows a stereoscopic system of two UV position sensitive detectors allowing the position of a fire to be determined in a three dimensional space.

It is to be noted that the UV sensitive photocathodes used may be a solid, gaseous or liquid photocathode.

The photocathode used in the above-described embodiments, as well as used in the prior art fire detector, comprises a photosensitive element of CsI (cesium-iodide). Several advantages are achieved by using such photocathode material. A first advantage of using CsI is that its sensitivity drops rapidly towards long wavelengths resulting in a fire detector being practically insensitive to visible light, which enables the use of it for detecting fires inside fully illuminated buildings. A second advantage is that a CsI photocathode can be exposed to air for a short period of time, about 5-10 minutes, without a considerable degradation of its quantum efficiency. This is very advantageous since the assembling of the fire detector is thereby greatly simplified. The detector assembling may be done in air and the cost of the detector is thereby reduced. A third advantage of using CsI as the photosensitive material is that it has practically no thermal emission, and thus no spurious pulses caused by thermoelectrons sporadically emitted from the photocathode. Thus, CsI is a much preferred material for use in a photocathode of the invention. However, although such a CsI photocathode detector is able to detect and record a single photoelectron and its sensitivity is enough to reliably detect a cigarette lighter on a distance of 30 m in a fully illuminated room, there is room for further yet improvements of the CsI photocathode.

Obviously, a prerequisite for enabling detection of fire is that the quantum efficiency of the photocathode material used in the fire detector overlaps the emission spectra of flames. The quantum efficiency curve of CsI only slightly overlaps with the fire emission spectra, as is shown in FIG. 8. In the figure, the quantum efficiency is plotted against the wavelengths, and a typical emission spectrum of flames in air is indicated by curve III and an emission spectrum of sunlight by curve IV. The quantum efficiency curve of CsI is shown by curve I, and as can be seen it only slightly overlaps with the emission spectra of flames. In contrast to this the quantum efficiency of CsTe (cesium-tellurium), shown by curve II, show a better overlap with the flame emission spectra. An even better sensitivity of the fire detector would thus be expected if using a CsTe photocathode. However, a CsTe photocathode cannot be exposed to air due to oxidation and fast degradation of the CsTe quantum efficiency, and such photocathode also has a strong thermal emission and therefore a high noise level.

In accordance with one embodiment of the present invention, the sensitivity of the fire detector is increased by the provision of an optimized double layer photocathode. The above-mentioned difficulties with a CsTe photocathode are overcome by the inventive double layer photocathode. With reference to FIG. 9 such a photocathode will now be described.

The inventive photocathode 80 comprises a conductive substrate 81 coated with a layer of CsTe 82. The CsTe layer 82 is coated by a thin layer of CsI, for example a few nanometres thick, preferably about 20 nm. The coating may be performed in any suitable manner, such as for example electro-plating, electrocoating, thin-film processes, chemical vapour deposition.

Incident UV photons from an UV source, such as for example a fire, pass through a UV transparent window, penetrate through the optically transparent CsI layer 83 and cause a photoelectric effect emanating from the CsI layer as well as from the CsTe layer. Photoelectrons from the CsTe layer have a high kinetic energy Eₖ
Eₖ=hν−φ
where φ is the work function of the boundary between the CsTe and CsI layers 82, 83. Due to this high kinetic energy the photoelectrons penetrate through the thin CsI layer 83 and enter the detector volume, in which they interact with the gas possibly creating avalanche amplification. The quantum efficiency of the inventive photocathode 80 is thus almost a sum of the quantum efficiency of CsTe and CsI. The problems with thermal emission of CsTe photocathodes are overcome by means of the inventive double layer photocathode, since the thermal photoelectrons have an energy that is too low to overcome the CsI layer 83, and are thus hindered to penetrate into the detector volume by the CsI layer 83. Therefore the double layer photocathode 80 will not emit thermal photoelectrons and the noise level is lower than what would be possible for a CsTe photocathode, and is in fact on a level of a CsI photocathode.

Further, the double layer photocathode 80 can be exposed to air for a short time, since the CsI layer 83 will protect the CsTe photocathode from direct contact with air. Therefore one of the advantages of CsI photocathodes is achieved, namely it may be assembled into the detector unit in air, whereby the manufacturing of the detector unit is greatly simplified and made less expensive.

It is possible to arrange the inventive double-layer structure on other photocathodes, such as for example SbCs, which has an even better overlap with the emission spectra of flames. The quantum efficiency of SbCs photocathode covered with a CsI coating is shown by curve V in FIG. 8.

What is claimed is:

1. A detector assembly for detecting vapours, said detector assembly comprising:
a detector unit comprising a UV sensitive photocathode and an anode;
a voltage supply unit connected to the UV sensitive photocathode and to the anode to create an electric field such that photoelectrons emitted from the UV sensitive photocathode when struck by UV light are forced to move towards the anode;
a readout arrangement for detecting charges induced by electrons moving towards the anode thereby generating a signal related to the intensity of detected UV light, wherein an artificial source for emitting radiation having wavelengths within a wavelength interval, the source being oriented such that UV light from the source can strike the UV sensitive photocathode;
said wavelength interval coinciding with a transmission band of air, and said wavelength interval further coinciding with an absorption band of vapours containing molecules of a complex structure; and
that said readout arrangement is arranged to detect a decrease of said signal between the detector and the source, whereby a presence of a vapour can be established.

2. Detector assembly as claimed in claim 1, wherein the detector assembly further is arranged to detect flames emitting UV-light by detecting an increase of said signal.

3. Detector assembly as claimed in claim 1, wherein said wavelength interval is 121.6 nm±5 nm.

4. Detector assembly as claimed in claim 1, wherein said wavelength interval is 121.6 nm±0.5 nm.

5. Detector assembly as claimed claim 2, wherein said vapour detection and said flame detection is performed essentially simultaneously.

6. Detector assembly as claimed claim 5, wherein the artificial light source is arranged to emit pulsed radiation, and the detector unit is arranged to detect said radiation from said artificial source at regular intervals.

7. Detector assembly as claimed in claim 5, wherein an additional detector unit is provided, and the two detector units are arranged to detect UV-light from flames and the artificial source, respectively, by being provided with different spectral filters.

8. Detector assembly as claimed in claim 1, wherein the detector unit includes a gas suitable for electron amplification.

9. Detector assembly as claimed in claim 1, wherein the distance between the detector unit and the source is a few cm, preferably about 1 cm.

10. Detector assembly as claimed in claim 1, wherein said wavelength interval is 120-185 nm.

11. Detector assembly as claimed in claim 1, wherein said detector unit and said source are arranged within a low-pressure chamber.

12. Detector assembly as claimed in claim 1, wherein air is circulated between said detector unit and said artificial source.

13. Detector assembly as claimed in claim 1, wherein said detector unit and said artificial source are mounted within a housing comprising one or more air passages.

14. Detector assembly as claimed in claim 13, wherein said one or more air passages comprise filtering means for filtering large-sized particles.

15. Detector as claimed in claim 1, wherein said vapours are one or more of the following: smoke from a fire, gasoline vapour, alcohol vapour or hazardous vapours.

16. Detector as claimed in claim 1, wherein said vapour is constituted by molecules containing more than three atoms.

17. Detector assembly as claimed in claim 1, wherein the source comprises a gas tight chamber including a wire connected to a voltage supply.

18. Detector assembly as claimed in claim 17, wherein said gas tight chamber contains a gas filling of Ar or H₂ at a pressure of 1 atm or below.

19. Detector assembly as claimed in claim 16, wherein said wire is arranged so as to create a corona discharge having a strong emission at λ=121.6 nm.

20. Detector assembly as claimed in claim 1, further comprising a vapour-identifying unit for identification of the particular vapour.

21. Detector assembly as claimed in claim 1, wherein said detector unit comprises a position-sensitive detector.

22. Detector as claimed in claim 1, wherein said photocathode comprises a layer of CsTe having a coating of CsI.

23. A method for detecting vapours by utilising a detector unit comprising a UV sensitive photocathode and an anode, a voltage supply unit connected to the UV sensitive photocathode and to the anode to create an electric field such that photoelectrons emitted from the UV sensitive photocathode when struck by UV light are forced to move towards the anode, and a readout arrangement for detecting charges induced by electrons moving towards the anode thereby generating a signal related to the intensity of detected UV light, said method comprising the steps of:
emitting, at an artificial source, radiation having wavelengths within a wavelength interval, said wavelength interval coinciding with a transmission band of air, and said wavelength interval further coinciding with an absorption band of vapours containing molecules of a complex structure;
emitting UV light from said source such that UV light from the source can strike the UV sensitive photocathode; and
detecting, at said readout arrangement, a decrease of said signal between the detector and the source, whereby a presence of a vapour can be established.

24. Method as claimed in claim 23, wherein flames emitting UV-light are further detected by detecting an increase of said signal.

25. Method as claimed in claim 23, wherein said wavelength interval is within an interval of 121.6 nm±5 nm.

26. Method as claimed in claim 23, wherein said wavelength interval is within an interval 121.6 nm±0.5 nm.

27. Method as claimed in claim 24, further comprising the step of detecting, by said detector assembly, flames and vapours essentially simultaneously.

28. Method as claimed in claim 27, further comprising the step of emitting, at the artificial light source, a pulsed radiation, and detecting, by said detector unit, radiation from said artificial source, at regular intervals.

29. Method as claimed in claim 23, wherein said method is performed within a low-pressure chamber comprising said detector unit and said artificial source.

30. Method as claimed in claim 23, further comprising the step of circulating air between said detector unit and said artificial source.

31. Method as claimed in claim 30, further comprising the step of filtering out large-sized particles from the air before said step of circulating the air.

32. Method as claimed in claim 23, wherein said vapours are one or more of the following: smoke from a fire, gasoline vapour, alcohol vapour or hazardous vapours.

33. Method as claimed in claim 23, wherein said vapour is constituted by molecules containing more than three atoms.

34. A photocathode excited by incident UV light, the photocathode comprising a conductive substrate coated with a layer of CsTe emitting photoelectrons characterised in that
said photocathode further comprises a coating of CsI on top of said CsTe layer.
